(19) United States
(12) Patent Application Publication
(10) Pub. No.: US 2006/0173083 A1
(43) Pub. Date: Aug. 3, 2006

(54) Arsenic-adsorbing ion exchanger

(76) Inventors: Reinhold Klipper, Koln (DE); Andreas Schlegel, Krefeld (DE); Wolfgang Podszun, Koln (DE); Rudiger Seidel, Sandersdorf (DE)

Correspondence Address: LANXESS CORPORATION, 111 RIDC PARK WEST DRIVE, PITTSBURGH, PA, 15275-1112, US

(21) Appl. No.: 11/299,098

(22) Filed: Dec. 8, 2005

(30) Foreign Application Priority Data
Jun. 13, 2003 (DE) 103 27 110.4

(51) Int. Cl. C08J 5/20

(52) U.S. Cl. 521/25

(57) ABSTRACT

The present invention relates to a method for producing iron oxide/iron oxyhydroxide-containing carboxyl-bearing ion exchangers, which is characterized in that a) a bead-type carboxyl-containing ion exchanger is contacted in aqueous suspension with iron(III) salts or a′) an aminomethylated crosslinked polystyrene bead polymer is contacted in aqueous suspension with iron(III) salts and with chloroacetic acid and b) the suspensions obtained from stages a) or a′) are adjusted to pHs in the range from 3 to 14 by adding alkali metal hydroxides or alkaline earth metal hydroxides and the resultant iron oxide/iron oxyhydroxide-containing ion exchangers are isolated by known methods, to the ion exchangers themselves their, and also to their use for the adsorption of heavy metals, in particular arsenic.

The present invention relates to a method for producing iron oxide/iron oxyhydroxide-containing carboxyl-bearing ion exchangers, which is characterized in that

a) a bead-type carboxyl-containing ion exchanger is contacted in aqueous suspension with iron(III) salts or

a′) an aminomethylated crosslinked polystyrene bead polymer is contacted in aqueous suspension with iron(III) salts and with chloroacetic acid and

b) the suspensions obtained from stages a) or a′) are adjusted to pHs in the range from 3 to 14 by adding alkali metal hydroxides or alkaline earth metal hydroxides and the resultant iron oxide/iron oxyhydroxide-containing ion exchangers are isolated by known methods.

The requirements for the purity of drinking water have significantly increased in recent decades. Health authorities of numerous countries have developed limit values for heavy metal concentrations in water. This also relates to arsenic.

Under certain circumstances, arsenic compounds can be extracted from rocks and thus pass into the ground water. In natural waters, arsenic occurs as oxidic compound having trivalent and pentavalent arsenic. It is found that, at the pHs prevailing in natural waters, the species H₃AsO₃, H₂AsO₃^{—}, H₂AsO₄^{—}, HAsO₄^{2—} chiefly occur.

Easily absorbed As compounds are highly toxic and carcinogenic.

In many regions of the USA, India, Bangladesh, China and also in South America, very high concentrations sometimes occur in the ground water.

Numerous medical studies now confirm that in humans who are exposed to such pollution over a long period, diseased skin changes (hyperkeratoses) and various types of tumor can develop as a result of chronic arsenic poisoning.

On the basis of medical studies, the World Health Organization WHO in 1992 recommended introducing internationally a limit value for arsenic in drinking water of 10 μg/l.

In many states of Europe and the USA, this value is still being exceeded. In Germany, 10 μg/l has been maintained since 1996, in countries of the EU, the limit value of 10 μg/l applies from 2003, and in the USA from 2006.

Ion exchangers are used in varied ways for purifying untreated waters, wastewaters and aqueous process streams. They are particularly effective in softening and desalting. Chelate resins are used in hydrometallurgy preferably for the adsorption of metal ions, in particular heavy metal ions or noble metal ions, and also their compounds, from aqueous solutions or organic media.

However, they do not exhibit the desired and necessary selectivity for all ions. In particular, arsenate ions cannot be removed to a sufficient extent using ion exchangers/chelate resins.

I. Rau et al, Reactive & Functional Polymers 54, ( 2003 ) 85-94 describe the removal of arsenate ions by chelate resins having iminodiacetic acid groups which are occupied (chelated) by iron(III) ions. In their production, the chelate resin having iminodiacetic acid groups in the acid form is occupied (chelated) by iron(III) ions. An iron oxide/iron oxyhydroxide phase highly specific for arsenic does not develop here, since on the occupation by Fe(III) ions, it is ensured that the pH does not exceed 2 (same publication, page 87).

Therefore, this adsorber is also not able to remove arsenic ions from aqueous solutions down to the necessary residual amounts.

There is therefore a requirement for novel bead-type ion exchangers or absorbers which are highly specific for arsenic ions, which in column methods exhibit a relatively low pressure drop, no abrasion, high mechanical and osmotic stability, and also a significantly lower pressure drop than the ion exchangers of the prior art and, further, in addition to arsenic, can also adsorb other heavy metals.

It is the object of the present invention to provide an ion-exchange resin for removing pollutants, preferably heavy metals, in particular arsenic, from liquids, preferably aqueous media or gases, and also the provision of a method for its production.

A method has now been found for producing iron oxide/iron oxyhydroxide-containing carboxyl-bearing ion exchangers, which is characterized in that

a) a bead-type carboxyl-containing ion exchanger is contacted in aqueous suspension with iron(III) salts or

a′) an aminomethylated crosslinked polystyrene bead polymer is contacted in aqueous suspension with iron(III) salts and with chloroacetic acid and

b) the suspensions obtained from stages a) or a′) are adjusted to pHs in the range from 3 to 14 by adding alkali metal hydroxides or alkaline earth metal hydroxides and the resultant iron oxide/iron oxyhydroxide-containing ion exchangers are isolated by known methods.

In the case of the bead-type carboxyl-containing ion exchangers, steps a) and b) can if appropriate be carried out repeatedly successively. Alternatively to the iron(III) salt, iron(II) salts can also be used which are wholly or partially oxidized to ironIII salts by known oxidation methods in the reaction medium.

The resultant bead polymers are brown and are distinguished, in contrast to the above described prior art, by the development of an iron oxide/iron oxyhydroxide phase which is highly specific for the adsorption of heavy metals, preferably arsenic.

According to the invention, heterodisperse or monodisperse carboxyl-containing ion exchangers or heterodisperse or monodisperse aminomethylated polystyrene bead polymers can be used.

Monodisperse ion exchangers in the present application denotes bead-type resins in which at least 90% by volume or by mass of the particles have a diameter which lies around the most frequent diameter in the interval having the width of ±10% of the most frequent diameter.

For example, in the case of resin beads having a most frequent diameter of 0.5 mm, at least 90% by volume or by mass are in a size interval between 0.45 mm and 0.55 mm, in the case of a resin bead having a most frequent diameter of 0.7 mm, at least 90% by volume or by mass are in a size interval between 0.77 mm and 0.63 mm.

Suitable carboxyl-containing ion exchangers for process step a) are weakly acidic ion exchangers based on crosslinked poly(meth)acrylic acid. For production of same, crosslinked (meth)acrylic esters and (meth)acrylonitrile are used.

As (meth)acrylic esters, use is made of unsaturated aliphatic (meth)acrylic esters, in particular methyl acrylate, ethyl acrylate and methyl methacrylate. As (meth)acrylonitrile, unsaturated aliphatic nitriles of the formula (I) are used.

Unsaturated aliphatic nitriles are characterized by the general formula (I), 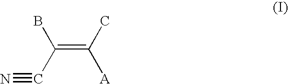
where

A, B and C each independently of one another are hydrogen, alkyl or halogen.

Alkyl, in the context of the present invention, is a straight-chain or branched alkyl radical having 1 to 8 carbon atoms, preferably having 1 to 4 carbon atoms. Halogen, in the context of the present invention, is chlorine, fluorine and bromine.

Preferred nitriles in the context of the present invention are acrylonitrile or methacrylonitrile; particularly preferably, acrylonitrile is used.

As crosslinker, use is made of divinyl-bearing aliphatic or aromatic compounds. These include divinylbenzene, 1,5-hexadiene, 1,7-octadiene, 2,5-dimethyl-1,5-hexadiene and also divinyl ethers.

Suitable divinyl ethers are compounds of the general formula (II), 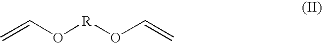
where

R is a radical of the series CnH₂ₙ, (CₘH₂ₘ—O)ₚ—CₘH₂ₘ or CH₂—C₆H₄—CH₂ and n>2, m=2to 8and p>1.

Suitable polyvinyl ethers in the case n>2 are trivinyl ethers of glycerol, trimethy-lolpropane or tetravinyl ethers of pentaerythritol.

Preferably, use is made of divinyl ethers of ethylene glycol, di-, tetra- or polyethylene glycol, butanediol or poly-THF, or the corresponding tri- or tetravinyl ethers. Particular preference is given to the divinyl ethers of butanediol and diethylene glycol as are described in EP-A 11 10 608.

The reaction (saponification) of the acrylic-containing bead polymers can be performed by acids or lyes.

Descriptions of the production of weakly acidic ion exchangers are given in Ullmanns Enzyklopädie der technischen Chemie (Ullmann's Encyclopedia of Industrial Chemistry), 5th edition, volume 14, pages 393 ff; US-A 2,885,371, DDR Patent 79,584, US-A 3427262 and EP-A 11 10 608.

In addition, in process step a), use can be made of carboxyl-containing chelation exchangers which contain aminoacetic acid and/or iminodiacetic acid groups. Chelate resins having acetic acid groups are preferably produced by functionalizing crosslinked styrene/divinylbezene bead polymers.

EP-A 0 980 711 and EP-A 1 078 690 describe the reaction of crosslinked heterodisperse or monodisperse crosslinked bead polymers based on styrene/divinylbenzene by the phthalimide method to give chelate resins having acetic acid groups. The contents of both publications are incorporated by the present application.

Alternatively, U.S. Pat. No. 4,444,961 describes, for example, a reaction of crosslinked macroporous bead polymers by the chloromethylation method to give chloromethylated bead polymer, and the subsequent reaction with iminodiacetic acid to give chelate resins having acetic acid groups, the contents of which are incorporated into the present application.

According to the invention, preferably, use is made of macroporous ion exchangers.

Macroporous bead polymers can be formed, for example, by adding inert materials (porogens) to the monomer mixture on the polymerization. Materials suitable as such are, especially, organic substances which dissolve in the monomer but dissolve or swell the polymer poorly (precipitant for polymers), for example aliphatic hydrocarbons (Farbenfabriken Bayer DBP 1045102, 1957; DBP 1113570, 1957).

An aminomethylated crosslinked polystyrene bead polymer which is suitable for method step a′) can be produced as follows for example: first, the amidomethylation reagent is produced. For this, for example phthalimide or a phthalimide derivative is dissolved in a solvent and admixed with formalin. Then, with elimination of water therefrom, a bis(phthalimido)methyl ether is formed. The bis(phthalimido)methyl ether can if appropriate be reacted to form the phthalimido ester. Preferred phthalimide derivatives are phthalimide itself or substituted phthalimides, for example methylphthalimide.

As solvents, use is made of inert solvents which are suitable for swelling the polymer, preferably chlorinated hydrocarbons, particularly preferably dichloroethane or methylene chloride. Further details are given in EP-A 0 980 711 and EP-A 10 78 690.

In a preferred embodiment of the present invention, the bead polymer is condensed with phthalimide derivatives. As catalyst here, use is made of oleum, sulfuric acid or sulfur trioxide.

The elimination of the phthalic acid residue and thus the exposure of the aminomethyl group are performed in this case by treating the phthalimidomethylated crosslinked bead polymer with aqueous or alcoholic solutions of an alkali metal hydroxide, such as sodium hydroxide or potassium hydroxide, at temperatures between 100 and 250° C., preferably 120-190° C. The concentration of the sodium hydroxide solution is in the range from 10 to 50% by weight, preferably 20 to 40% by weight. This method makes possible the production of aminoalkyl-containing crosslinked bead polymers having a substitution of the aromatic nuclei greater than 1.

The resultant aminomethylated bead polymer can be washed alkali-free with demineralized water.

As iron(III) salts in method step a) or a′), use can be made of all soluble iron(III) salts, in particular use is made of iron(III) chloride, sulfate, nitrate.

As iron(II) salts, use can be made of all soluble iron(II) salts, in particular use is made of iron(II) chloride, sulfate, nitrate. Preferably, the oxidation of the iron(II) salts in the suspension in method step a) or a′) is performed by air.

The iron(II) salts and iron(III) salts can be used solvent-free or as aqueous solutions.

The concentration of the iron salts in aqueous solution can be chosen freely. Preferably, solutions having iron salt contents of 10 to 20% by weight are used.

The metering of the aqueous iron salt solution is not critical with respect to time. It can, depending on the technical conditions, take place as speedily as possible.

Per mole of iron salt used, use is made of 0.1 to 2 mol, preferably 0.5 to 1.3 mol, of alkali metal hydroxides or alkaline earth metal hydroxides.

Per mole of carboxyl group in the ion exchanger, use is made of 0.1 to 1.5 mol, preferably 0.3 to 0.8 mol of iron salt.

In method step a′), in aqueous suspension, aminomethylated crosslinked bead polymers are loaded with iron(III) ions and additionally reacted with chloroacetic acid in alkaline environment to give a bead polymer which contains not only chelating iminoacetic acid groups, but also iron oxide/iron hydroxide.

Per mole of aminomethyl groups in the aminomethylated ion exchanger, use is made of 2 to 3 mol of chloroacetic acid, preferably 2 to 2.5 mol of chloroacetic acid.

The chloroacetic acid, preferably monochloroacetic acid, is metered over a period of 2 to 6 hours, preferably 3 to 5 hours. Chloroacetic acid is metered at temperatures between 60 and 100° C., preferably at temperatures between 75 and 95° C.

The suspensions obtained from method steps a) and a′) have a pH of<3.

The pH in method step b) is set by means of alkali metal hydroxides or alkaline earth metal hydroxides, in particular potassium hydroxide, sodium hydroxide or calcium hydroxide.

The pH range in which the formation of iron oxide/iron oxyhydroxide groups takes place is in the range between 3 and 14, preferably 3 and 8, particularly preferably between 4 and 7.

Per mole of iron salt used, use is made of 0.1 to 2 mol, preferably 0.5 to 1.3 mol, of alkali metal hydroxide or alkaline earth metal hydroxide.

Said substances are preferably used as aqueous solutions.

The concentration of the aqueous alkali metal hydroxide or alkaline earth metal hydroxide solutions can be up to 50% by weight. Preferably, use is made of aqueous solutions having an alkali metal hydroxide or alkaline earth metal hydroxide concentration in the range from 10 to 20% by weight.

The rate of metering of the aqueous solutions of alkali metal hydroxide or alkaline earth metal hydroxide depends on the level of the desired pH and the technical conditions. For example, 60 minutes are required for this.

After the desired pH is reached, the mixture is further stirred for 0.1 to 10 hours, preferably 1 to 4 hours.

The aqueous solutions of alkali metal hydroxide or alkaline earth metal hydroxide are metered at temperatures between 15 and 95° C., preferably at 20 to 50° C.

Per milliliter of carboxyl-bearing or aminomethyl-bearing ion exchange resin, use is made of 0.5 to 3 ml of deionized water to achieve good stirrability of the resin.

Without proposing a mechanism for the present application, in method step b), apparently as a result of the pH change in the pores of the ion exchange resins, FeOOH compounds are formed which bear OH groups which are freely accessible at the surface. The arsenic is then apparently removed via an exchange of OH^{—} for HAsO₄^{2—}or H₂AsO₄^{—}, with formation of an AsO—Fe bond.

Equally capable of the ion exchange are also ions isostructural with HAsO₄^{2—} or H₂AsO₄^{—}, for example H₂PO₄^{—}, VO—, MoO—, WO—, SbO anions.

According to the invention, preferably use is made of NaOH or KOH as base. However, any other base can also be used which leads to the formation of FeOH groups, for example NH₄OH, Na₂CO₃, CaO, Mg(OH)₂ etc.

Isolating in the context of the present invention means separating off the ion exchanger from the aqueous suspension and purification thereof. The separation is carried out by measures known to those skilled in the art such as decanting, centrifugation, filtration. The purification is performed by washing with, for example, deionized water and can comprise classification for separating off fine fractions or coarse fractions. If appropriate, the resultant iron oxide/iron oxyhydroxide-containing ion exchanger can be dried, preferably by reduced pressure and/or particularly preferably at temperatures between 20° C. and 180° C.

The present invention also relates however to the products obtainable by the inventive method, that is to say iron oxide/iron oxyhydroxide-containing carboxyl-bearing ion exchangers obtainable by contacting

a) a bead-type carboxyl-containing ion exchanger in aqueous suspension with iron(III) salts or

a′) an aminomethylated crosslinked polystyrene bead polymer in aqueous suspension with iron(III) salts and with chloroacetic acid and

b) adding alkali metal hydroxides or alkaline earth metal hydroxides to the suspensions obtained from stages a) or a′) and setting a pH in the range from 3 to 14, and also isolating the resultant iron oxide/iron oxyhydroxide-containing ion exchangers by known methods.

Surprisingly, the inventive iron oxide/iron oxyhydroxide-containing ion exchangers not only adsorb arsenic in its most varied forms, but in addition heavy metals, for example, cobalt, nickel, lead, zinc, cadmium, copper.

The inventive iron oxide/iron oxyhydroxide-containing ion exchangers can be used for purifying drinking water, wastewater streams of the chemical industry, and also refuse incineration plants. A further use of the inventive ion exchangers is purification of leachate waters from landfills.

The inventive iron oxide/iron oxyhydroxide-containing ion exchangers are preferably used in apparatuses suitable for their tasks.

The invention therefore also relates to apparatuses through which a liquid to be treated can flow, preferably filtration units, particularly preferably adsorption containers, in particular filter adsorption containers, containing iron oxide/iron oxyhydroxide-containing ion exchangers obtainable by the method described in this application, for removing heavy metals, in particular arsenic, from aqueous media, preferably drinking water or gases. The apparatuses can be connected, e.g., in the household to the sanitary and drinking water facilities.

According to the invention the iron oxide/iron oxyhydroxide-containing ion exchangers can be used in combination with other adsorbents, for example activated carbon. The present invention therefore also relates to apparatuses through which a liquid to be treated can flow which, in addition to iron oxide/iron oxyhydroxide-containing ion exchangers comprise other adsorbents.

For the measurement of the adsorption of arsenic(III) and arsenic(V), in a 5 L PE flask (L=liter), over a defined period, 3 l of an aqueous solution of NaAsO₂ or Na₂HAsO₄ having the respective specified concentration of approximately 2-3 mg/l of arsenic are treated with 3 g of the sample under test and the flask set in motion on rotating rollers. The adsorption rate of As ions to iron hydroxide over a defined period is reported.

### EXAMPLES

### Example 1

1a) Production of the Monodisperse Macroporous Bead Polymer Based on Styrene, Divinylbezene and Ethylstyrene

3000 g of demineralized water are placed in a 10 l glass reactor and a solution of 10 g of gelatin, 16 g of disodiumhydrogenphosphate dodecahydrate and 0.73 g of resorcinol in 320 g of deionized water are added and mixed. The mixture is heated to 25° C. With stirring, then a mixture of 3200 g of microencapsulated monomer droplets having a narrow particle size distribution of 3.6% by weight of divinylbenzene and 0.9% by weight of ethylstyrene (used as commercially conventional isomeric mixture of divinylbenzene and ethylstyrene having 80% divinylbenzene), 0.5% by weight of dibenzoyl peroxide, 56.2% by weight of styrene and 38.8% by weight of isododecane (technical-grade isomeric mixture having a high fraction of pentamethylheptane) is added, the microcapsules consisting of a formaldehyde-cured complex coacervate of gelatin and a copolymer of acrylamide and acrylic acid, and 3200 g of aqueous phase having a pH of 12 are added. The mean particle size of the monomer droplets is 460 μm.

The batch, with stirring, is polymerized to completion by temperature elevation according to a temperature program starting at 25° C. and finishing at 95° C. The batch is cooled, washed over a 32 μm screen and then dried in a vacuum at 80° C. This produces 1893 g of a bead-type polymer having a mean particle size of 440 μm, narrow particle size distribution and smooth surface.

The polymer is chalky white in appearance and has a bulk density of approximately 370 g/l.

### Example 1a′

1a′) Production of the Monodisperse Macroporous Bead Polymer Based on Styrene, Divinylbenzene and Ethyl Styrene

3000 g of demineralized water are placed in a 10 l glass reactor and a solution of 10 g of gelatin, 16 g of disodiumhydrogenphosphate dodecahydrate and 0.73 g of resorcinol in 320 g of deionized water are added and mixed. The mixture is heated to 25° C. With stirring, then a mixture of 3200 g of microencapsulated monomer droplets having a narrow particle size distribution of 8.0% by weight of divinylbenzene and 2.0% by weight of ethylstyrene (used as commercially conventional isomeric mixture of divinylbenzene and ethylstyrene having 80% divinylbenzene), 0.5% by weight of dibenzoyl peroxide, 52.0% by weight of styrene and 37.5% by weight of isododecane (technical-grade isomeric mixture having a high fraction of pentamethylheptane) is added, the microcapsules consisting of a formaldehyde-cured complex coacervate of gelatin and a copolymer of acrylamide and acrylic acid, and 3200 g of aqueous phase having a pH of 12 are added. The mean particle size of the monomer droplets is 460 μm.

The batch, with stirring, is polymerized to completion by temperature elevation according to a temperature program starting at 25° C. and ending at 95° C. The batch is cooled, washed over a 32 μm screen and then dried in a vacuum at 80° C. This produces 1893 g of a bead-type polymer having a mean particle size of 440 μm, narrow particle size distribution and smooth surface.

The polymer is chalky white in appearance and has a bulk density of approximately 370 g/l.

1b) Production of the Amidomethylated Bead Polymer

At room temperature, 2373 g of dichloroethane, 705 g of phthalimide and 505 g of 29.2% strength by weight formalin are charged. The pH of the suspension is set to 5.5 to 6 using sodium hydroxide solution. The water is then removed by distillation. Then, 51.7 g of sulfuric acid are added. The water formed is removed by distillation. The batch is cooled. At 30° C., 189 g of 65% strength by weight oleum and then 371.4 g of monodisperse bead polymer produced according to method step 1a) or 1a′) are added. The suspension is heated to 70° C. and stirred for a further 6 hours at this temperature. The reaction broth is taken off, deionized water is added and residual amounts of dichloroethane are removed by distillation.

Yield of amidomethylated bead polymer: 2140 ml

Composition by elemental analysis:

Carbon: 75.3% by weight;

Hydrogen: 4.9% by weight;

Nitrogen: 5.8% by weight;

Remainder: Oxygen.

1c) Production of the Aminomethylated Bead Polymer

1019 g of 45% strength by sodium hydroxide solution and 406 ml of demineralized water are added at room temperature to 2100 ml of amidomethylated bead polymer. The suspension is heated to 180° C. and stirred for 6 hours at this temperature. The resultant bead polymer is washed with demineralized water.

Yield of aminomethylated bead polymer: 1770 ml

As overall yield, projected, this gives 1804 ml

Composition by elemental analysis: Nitrogen: 11.75% by weight

From the composition by elemental analysis of the aminomethylated bead polymer, it can be calculated that on a statistic average per aromatic nucleus, based on the styrene and divinylbenzene units, 1.17 hydrogen atoms have been substituted by aminomethyl groups.

1d) Production of the Ion Exchanger Having Chelating Iminodiacetic Acid Groups

1180 ml of aminomethylated bead polymer from Example 1c) are added at room temperature to 1890 ml of demineralized water. To this suspension are added 729.2 g of sodium salt of monochloroacetic acid. The mixture is stirred for 30 minutes at room temperature. Then the pH of the suspension is set to pH 10 using 20% strength by weight sodium hydroxide solution. In 2 hours, the suspension is heated to 80° C. The mixture is then stirred for a further 10 hours at this temperature. During this time the pH is kept at 10 by controlled addition of sodium hydroxide solution.

Thereafter, the suspension is cooled. The resin is washed chloride-free with demineralized water.

Yield: 2190 ml

Total capacity of the resin: 2.39 mol/l of resin

### Example 2

Production of a chelate resin of the iminodiacetic acid type loaded with iron oxide/iron oxyhydroxide

400 ml of the chelate resin containing iminodiacetic acid groups produced according to Example 1 are admixed with 750 ml of aqueous iron(III) chloride solution which contains 103.5 g of iron(III) chloride per liter, and 750 ml of deionized water and stirred for 2.5 hours at room temperature. Then, a pH of 6 is set using 10% strength by weight sodium hydroxide solution and maintained for 2 h.

Thereafter, the ion exchanger is filtered off over a screen and washed with deionized water until the effluent is clear.

Resin yield: 380 ml

The Fe content of the loaded ion exchanger beads was determined by titrimetry as 14.4%.

As crystalline phase, α-FeOOH may be identified from powder diffractograms.

13.1 g of the ion exchanger, of which about 3.0 g account for FeOOH, were contacted with an aqueous solution of Na₂HAsO₄ and the decrease in As(V) concentration over time is recorded.

As(V) contents in the filtrate [μg/l] after x min

| 0′ | 5′ | 10′ | 30′ | 60′ | 120′ | 360′ |
|---|---|---|---|---|---|---|
| 2700 | 2000 | 1800 | 1400 | 1100 | 630 | 120 |

### Example 3

Production of an iron oxide/iron oxyhydroxide-containing weakly acidic ion exchanger having carboxyl groups 300 ml of a weakly acidic ion exchanger having carboxyl groups produced according to EP-A-11 10 608 are admixed with 1500 ml of aqueous iron(III) chloride solution which contains 103.5 g of iron(III) chloride per liter, and with 750 ml of deionized water. This mixture is stirred for 2.5 hours at room temperature. Then, a pH of 6 is set using 10% strength by weight sodium hydroxide solution and maintained for 120 minutes.

Thereafter, the ion exchanger is filtered off over a screen and washed with deionized water to neutrality, or until the effluent is clear.

Resin yield: 240 ml

% by weight iron in the resin: 12.0

As crystalline phase, α-FeOOH may be identified from powder diffractograms.

### Example 4

Production of an iron oxide/iron oxyhydroxide-containing chelate resin of the iminodiacetic acid type

500 ml of an aminomethylated bead polymer produced according to Example 1c are placed in 375 ml of deionized water. To this is added 750 ml of aqueous iron(III) chloride solution which contains 103.5 g of iron(III) chloride per liter. The suspension is heated to 90° C. At 90° C., 268 g of monochloroacetic acid are metered in the course of 4 hours. The pH is set to pH 9.2 using 50% strength by weight aqueous KOH solution. After metering is complete, the temperature is heated to 95° C.; the pH is set to 10.5 and the mixture is stirred for a further 6 hours at 95° C. and pH 10.5. After cooling, the resin is filtered off and washed to neutrality with deionized water.

Resin yield: 750 ml

% by weight iron in the resin: 1.2

As crystalline phase, α-FeOOH may be identified from powder diffractograms.

1. A method for producing an iron oxide/iron oxyhydroxide-containing carboxyl-bearing ion exchanger, characterized in that
a) a bead-type carboxyl-containing ion exchanger is contacted in aqueous suspension with iron(III) salts or
a′) an aminomethylated crosslinked polystyrene bead polymer is contacted in aqueous suspension with iron(III) salts and with chloroacetic acid and
b) the suspensions obtained from stages a) or a′) are adjusted to pHs in the range from 3 to 14 by adding alkali metal hydroxides or alkaline earth metal hydroxides and the resultant iron oxide/iron oxyhydroxide-containing ion exchanger is isolated by known methods.

2. An iron oxide/iron oxyhydroxide-containing carboxyl-bearing ion exchanger obtainable by contacting
a) a bead-type carboxyl-containing ion exchanger in aqueous suspension with iron(III) salts or
a′) an aminomethylated crosslinked polystyrene bead polymer in aqueous suspension with iron(III) salts and with chloroacetic acid and
b) adding alkali metal hydroxides or alkaline earth metal hydroxides to the suspensions obtained from stages a) or a′)
and setting a pH in the range from 3 to 14, and also isolating the resultant iron oxide/iron oxyhydroxide-containing ion exchanger by known methods.

3. The use of the iron oxide/iron oxyhydroxide-containing ion exchangers for adsorbing heavy metals, preferably arsenic, cobalt, nickel, lead, zinc, cadmium, copper.

4. An apparatus, preferably filtration unit, comprising iron oxide/iron oxyhydroxide-containing ion exchanger as claimed in claim 2, characterized in that it is used for removing heavy metals, preferably arsenic, from aqueous media or gases.

5. The use of the iron oxide/iron oxyhydroxide-containing ion exchanger as claimed in claim 3, characterized in that it is used in combination with other adsorbents.

6. The apparatus as claimed in claim 4, characterized in that it comprises other adsorbents in addition to the iron oxide/iron oxyhydroxide-containing ion exchanger.

7. The use of the apparatus as claimed in claims 4 or 6 in sanitary and drinking water facilities.
